(19) United States
(12) Patent Application Publication
(10) Pub. No.: US 2023/0272910 A1
(43) Pub. Date: Aug. 31, 2023

(54) FLARE MONITORING SYSTEM AND METHOD

(71) Applicant: Johnson Controls Tyco IP Holdings LLP, Milwaukee, WI (US)

(72) Inventors: Himanshu Goyal, Meerut (IN); Gregory A. Makowski, Los Altos, CA (US); Mohamad A. Ibrahim, Dammam (SA); Sastry Kim Malladi, Fremont, CA (US); Vilas V. Jangale, Sunnyvale, CA (US); Rohit Patwardhan, Dhahran (SA); Kalpesh M. Patel, Dhahran (SA); Turki Mutairy, Dhahran (SA)

(21) Appl. No.: 18/114,729

(22) Filed: Feb. 27, 2023

Related U.S. Application Data
(60) Provisional application No. 63/314,247, filed on Feb. 25, 2022.

(51) Int. Cl. F23G 7/08; G06T 7/20; G06T 7/11

(52) U.S. Cl. CPC F23G 7/085; G06T 7/20; G06T 7/11; F23G 2900/55006

(57) ABSTRACT

A flare monitoring system includes a camera configured to capture one or more images of a burning portion of a hydrocarbon gas emitted from a flare stack, memory circuitry storing instructions thereon, and processing circuitry configured to execute the instructions to estimate a flow rate of the hydrocarbon gas based on first data corresponding to the one or more images, and based on second data corresponding to an internal diameter of the flare stack.

### CROSS REFERENCE TO RELATED APPLICATIONS

This application claims priority to and the benefit of U.S. Provisional Application Ser. No. 63/314,247, entitled “EDGE AI BASED FLARE MONITORING TO REDUCE GLOBAL WARMING,” filed Feb. 25, 2022, and is hereby incorporated by reference in its entirety for all purposes.

### BACKGROUND

This section is intended to introduce the reader to various aspects of art that may be related to various aspects of the present disclosure and are described below. This discussion is believed to be helpful in providing the reader with background information to facilitate a better understanding of the various aspects of the present disclosure. Accordingly, it should be noted that these statements are to be read in this light, and not as admissions of prior art.

Hydrocarbon (e.g., oil) extraction, refining, and/or processing sites may flare (e.g., burn) hydrocarbon gases, such as stranded natural gas, for a variety of reasons. An environmental impact of gas flaring may be limited or reduced by proper operation and maintenance of a flare stack, a flare header, and other associated equipment. In other words, the environmental impact of gas flaring may be more pronounced by improper operation and/or failure to maintain the flare stack, the flare header, and the other associated equipment. For example, if a flow rate of the hydrocarbon gas within the flare stack and/or the flare header deviates from a desired flow rate, the environmental impact may be increased.

In traditional embodiments, a flow rate sensor, such as an ultrasonic flow rate, may be employed to monitor the flow rate of the hydrocarbon gas. Unfortunately, flow rate sensors may be expensive and susceptible to failure. Accordingly, it is now recognized that improved flare monitoring systems and techniques are desired.

### SUMMARY

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a flare monitoring system includes a camera configured to capture one or more images of a burning portion of a hydrocarbon gas emitted from a flare stack, memory circuitry storing instructions thereon, and processing circuitry configured to execute the instructions to estimate a flow rate of the hydrocarbon gas based on first data corresponding to the one or more images, and based on second data corresponding to an internal diameter of the flare stack.

In another embodiment, one or more tangible, non-transitory, computer-readable media stores instructions thereon that, when executed by one or more processors, are configured to cause the one or more processors to receive first data corresponding to one or more images taken by a camera of a burning portion of a hydrocarbon gas emitted from a flare stack, receive second data corresponding to an internal diameter of the flare stack, and estimate, based on the first data and the second data, a flow rate of the hydrocarbon gas through the flare stack or a flare header upstream of the flare stack.

In another embodiment, a method includes capturing, via a camera assembly, one or more images of a burning portion of a hydrocarbon gas emitted from a flare stack. The method also includes receiving, via processing circuitry, first data corresponding to the one or more images. The method also includes estimating, via the processing circuitry, based on the first data, and based on second data corresponding to an internal diameter of the flare stack, a flow rate of the hydrocarbon gas through the flare stack or a flare header upstream of the flare stack.

### BRIEF DESCRIPTION OF THE DRAWINGS

Various aspects of this disclosure may be better understood upon reading the following detailed description and upon reference to the drawings in which:

FIG. 1 is a schematic view of a system including a gas flare assembly and a flare monitoring assembly, in accordance with an aspect of the present disclosure;

FIG. 2 is an illustration of an image of a flare captured by a camera of the flare monitoring assembly of FIG. 1 and a reproduction of the image with superimposed rectangular bounding boxes determined by the flare monitoring assembly of FIG. 1, in accordance with an aspect of the present disclosure;

FIG. 3 is an illustration of an image of a flare captured by a camera of the flare monitoring assembly of FIG. 1 and a reproduction of the image with superimposed polygon masks determined by the flare monitoring assembly of FIG. 1, in accordance with an aspect of the present disclosure;

FIG. 4 is a process flow diagram corresponding to a process performed by the flare monitoring assembly of FIG. 1 to determine key performance indicators (KPIs), such as a gas flow rate, corresponding to the gas flare assembly of FIG. 1, in accordance with an aspect of the present disclosure;

FIG. 5 is a schematic view of a portion of the flare monitoring assembly of FIG. 1, in accordance with an aspect of the present disclosure;

FIG. 6 is a process flow diagram illustrating one or more algorithms employed in the process of FIG. 4, in accordance with an aspect of the present disclosure; and

FIG. 7 is an illustration of key performance indicators (KPIs) presentable on a graphical user interface (GUI), determined by the flare monitoring assembly of FIG. 1, and corresponding to first and second flare stacks of the gas flare assembly of FIG. 1, in accordance with an aspect of the present disclosure.

### DETAILED DESCRIPTION

One or more specific embodiments will be described below. In an effort to provide a concise description of these embodiments, not all features of an actual implementation are described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features.

The present disclosure is directed to employing a camera and various processing features to monitor a flare corresponding to a burning of a hydrocarbon gas emitted from a flare stack. For example, a flare monitoring system includes the camera, memory circuitry storing instructions thereon, and processing circuitry configured to execute the instructions to perform various functions. The camera may be configured to capture various images (e.g., via a video stream) and the processing circuitry may be configured to estimate a flow rate of the hydrocarbon gas within the flare stack or a flare header downstream of the flare stack based on data indicative of the images and an internal diameter of the flare stack (e.g., a tip of the flare stack). For example, the processing circuitry may execute one or more algorithms to detect a size of the flare (e.g., via rectangular bounding boxes, polygon masks, or both) and then estimate the flow rate of the hydrocarbon gas based on the size of the flare and the internal diameter of the flare stack.

Other inputs may also be employed to estimate the flow rate of the hydrocarbon gas. For example, a pressure of the hydrocarbon gas within the flare stack or the flare header, a temperature of the hydrocarbon gas within the flare stack or the flare header, a wind speed adjacent to the flare stack, an angle of the flare, a material composition of the hydrocarbon gas, other parameters associated with the system, or any combination thereof may be employed to estimate the flow rate of the hydrocarbon gas. Various sources corresponding to the above-described inputs may be employed, such as sensors (e.g., corresponding to the pressure, the temperature, the wind speed, or any combination thereof), a historical model (e.g., such as an autoregressive model (ARIMA) that estimates wind speed based on historic wind speed data), and/or other sources may be employed. Further, at least one additional key performance indicators (KPI) other than the flow rate of the hydrocarbon gas may be determined by the processing circuitry. based on one or more outputs of the flare monitoring system.

By employing the above-described features, the flow rate of the hydrocarbon gas may be determined (e.g., within an error margin) without the use of a traditional flow monitoring sensor, such as an ultrasonic sensor, which may be expensive and susceptible to failure. Further, operation of the flare stack, the flare header, or other downstream equipment may be adjusted based on one or more outputs of the flare monitoring system such that an environmental impact of the hydrocarbon gas flaring is limited or otherwise reduced. These and other features are described in detail below with reference to the drawings.

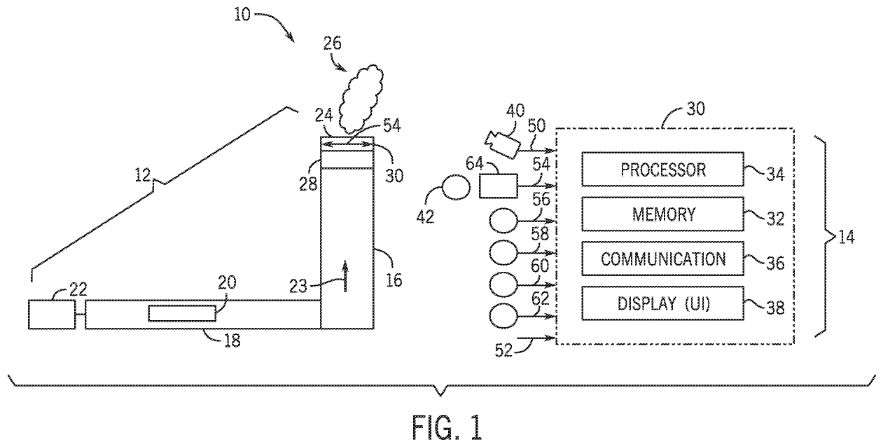

Turning now to the drawings, FIG. 1 is a schematic view of an embodiment of a system 10 including a gas flare assembly 12 and a flare monitoring assembly 14. The gas flare assembly 12 may include, for example, a flare stack 16, a flare header 18 downstream of the flare stack 16, componentry 20 of the flare header 18, and additional componentry 22 downstream of the flare header 18. While only one flare stack 16 is shown in the illustrated embodiment, it should be noted that multiple flare stacks 16 may be employed in other embodiments.

The additional componentry 22, the flare header 18 (e.g., including the componentry 20), and the flare stack 16 may be controlled to direct a hydrocarbon gas 23 (e.g., natural gas) toward a tip 24 of the flare stack 16, where the hydrocarbon gas 23 is burned to produce a flare 26. For example, an ignition device 28 and a pilot flame tip 30 may coordinate to produce a pilot light (or flame) that burns the hydrocarbon gas 23 as it exits the tip 24 of the flare stack 16, thereby producing the flare 26. It should be noted that the ignition device 28 and the pilot flame tip 30, among other componentry in FIG. 1, are illustrated schematically and may look different and/or be positioned in other locations in certain embodiments of the present disclosure.

The flare monitoring assembly 14 may include a control device 30 (e.g., controller, control assembly, etc.) having memory circuitry 32 storing instructions thereon and processing circuitry 34 configured to execute the instructions to perform various functions. The control device 30 may also include communication circuitry 36 configured to establish communication between the control device 30 and various other componentry described below. Further, the control device 30 may include a display 38. In some embodiments, the display 38 may include a user interface (UI) (e.g., a touchscreen) configured to receive inputs entered by a user. In other embodiments, the control device 30 may include a UI separate from the display 38, such as a keyboard, a mouse, buttons, or any combination thereof. Further, it should be noted that each of the memory circuitry 32, the processing circuitry 34, and the communication circuitry 36 may include one or more components. For example, the processing circuitry 34 may correspond to one process or multiple processors.

The flare monitoring assembly 14 may also include a camera assembly 40 (e.g., one or more cameras, such as one or more RGB cameras), a wind sensor 42, a gas pressure sensor 44, a gas temperature sensor 46, an ambient air density sensor 48, and/or a gas composition/density sensor 49. The type of camera(s) employed in the camera assembly 40 may be selected based on desired speed and/or accuracy of processing. For example, presently disclosed embodiments may be capable of quickly estimating flow rate and/or other KPIs via the use of a low cost, low resolution (e.g., 2 megapixels) daylight camera, although higher cost, higher resolution cameras may be employed (e.g., for higher accuracy). The sensors 42, 44, 46, 48, 49 are illustrated adjacent the control device 30 for simplicity in FIG. 1, but it should be understood that the sensors 42, 44, 46, 48, 49 may be disposed elsewhere. For example, the wind sensor 42 and the ambient air density sensor 48 may be disposed adjacent the tip 24 of the flare stack 16 and/or the flare 26, and the gas pressure sensor 44, the gas temperature sensor 46, and the gas composition/density sensor 49 may be disposed within the flare stack 16 or the flare header 18. As described in greater detail below, in certain embodiments, one or more of the sensors 42, 44, 46, 48, 49 may not be employed.

In accordance with the present disclosure, the control device 30 may be configured to receive a first input 50 corresponding to data indicative of images taken by the camera assembly 40 of the flare 26. In some embodiments, the first input 50 may correspond to data indicative of a video feed (e.g., having various images therein) captured by the camera assembly 40. The control device 30 may also be configured to receive a second input 52 corresponding to data indicative of an internal diameter 54 of the flare stack 16 (e.g., adjacent the tip 24 of the flare stack 16 or elsewhere in the flare stack 16). In some embodiments, the data indicative of the internal diameter 54 of the flare stack 16 may be entered to the control device 30 (e.g., via the display 38 or UI). Further, in some embodiments, the control device 30 may be configured to determine various key performance indicators (KPIs) of the gas flare assembly 12, such as a volume flow rate per second of the hydrocarbon gas 23 through the flare stack 16, based only on the first input 50 and the second input 52. That is, in certain embodiments, the wind sensor 42, the gas pressure sensor 44, the gas temperature sensor 46, the ambient air density sensor 48, and/or the gas composition/density sensor 49 may not be employed or may not be necessary. However, in certain other embodiments, at least one input corresponding to at least one of the sensors 42, 44, 46, 48, 49 may be employed, as described below, and may improve an accuracy of one or more of the KPIs corresponding to the gas flare assembly 12 that are determined by the flare monitoring assembly 14.

For example, the control device 30 may receive a third input 54 corresponding to data indicative of a wind speed detected by the wind sensor 42, a fourth input 56 corresponding to data indicative of a pressure of the hydrocarbon gas 23 within the flare stack 16 and detected by the gas pressure sensor 44, a fifth input 58 corresponding to data indicative of an ambient air density detected by the ambient air density sensor 48, and/or a sixth input 60 corresponding to data indicative of a gas composition and/or gas density detected by the gas composition/density sensor 49. In some embodiments, one or more of the inputs 56, 58, 60, 62 may be employed without the use of the corresponding sensor 44, 46, 48, 49, respectively. For example, in certain embodiments, a wind speed estimation module 64 may be employed with or without the use of the wind speed sensor 42. Further, in certain embodiments, the gas composition and/or density may be entered to the control device 30 (e.g., via the display 38 or UI) or otherwise known by the control device 30 without the use of the gas composition/density sensor 49.

In general, the control device 30 may employ at least the first input 50 (e.g., corresponding to data indicative of images taken by the camera assembly 40) and the second input 52 (e.g., corresponding to the internal diameter 54 of the flare stack 16) to determine one or more KPIs of the gas flare assembly 12. For example, as described in greater detail with reference to later drawings, the control device 30 may perform various functions to identify, based on the first input 50, one or more rectangular bounding boxes (e.g., via object detection) or one or more polygon masks (e.g., via instance segmentation) corresponding to the flare 26. Object detection or instance segmentation, referred to generically herein as computer vision models and/or edge machine learning (edgeML) models, may be selected based on desired processing speed and/or accuracy. In general, in certain embodiments one or both of these models may include various computer vision features, such as background subtraction from the image(s) by recognizing constant or semi-constant background pixels and subtracting them from the constantly moving fire/smoke pixels in the foreground. Other image augmentation features, such as random shear, rotation, horizontal flipping and scale jittering may also be employed. Further still, a correlation tracker model may be employed to learn correlation filters and predict whether fire (or flame) and/or smoke is present in a current frame to improve recall performance. These and other features are described in detail below.

Flare size (e.g., flame size, smoke size, flare and smoke size, etc.) may be inferred from the one or more rectangular rounding boxes or one or more polygon masks, which may be employed, along with the second input 52, to estimate one or more KPIs of the gas flare assembly 12, such as the flow rate of the hydrocarbon gas 23 through the flare stack 16. As previously described, the third input 54, the fourth input 56, the fifth input 58, the sixth input 60, the seventh input 62, or any combination thereof may also be employed by the control device 30 to estimate one or more KPIs of the gas flare assembly 12. In addition to the flow rate of the hydrocarbon gas 23 through the flare stack 16, the control device 30 may determine additional KPIs, such as flame area, smoke area, smoke-to-flame ratio, flame-to-smoke ratio, flame angle, etc. It should be noted that, in accordance with the present disclosure, the KPIs may be estimated in real-time or in near real-time by the control device 30 (e.g., via a Real Time Streaming Protocol (RTSP) at a desired frame rate). Accordingly, any abnormal KPIs may be addressed as described below.

In certain embodiments, the control device 30 may change operation of one or more components of the gas flare system 12 based on one or more of the estimated KPIs. Indeed, the control device 30 may change operation of the componentry 20 in the flare header 18, the additional componentry 22 downstream of the flare header 16, or other componentry (e.g., the ignition device 28, the pilot flame tip 30, etc.) within the flare stack 16 or elsewhere in the gas flare assembly 12. Such componentry may include, for example, a flashback prevention section, relief lines, a liquid knockout drum, water drains, oil drains, a flashback seal drum, a purge gas section, a gas recovery section, valves, pumps, other traditional componentry of gas flare systems, etc. The control device 30 may change operation of such componentry in response to one or more KPIs meeting a pre-defined relationship with one or more KPI thresholds (e.g., where the one or more KPIs exceed the one or more KPI thresholds). As an example, the control device 30 may change operation of such componentry in response to the estimated gas flow rate exceeding a first threshold, falling below a second threshold, or both.

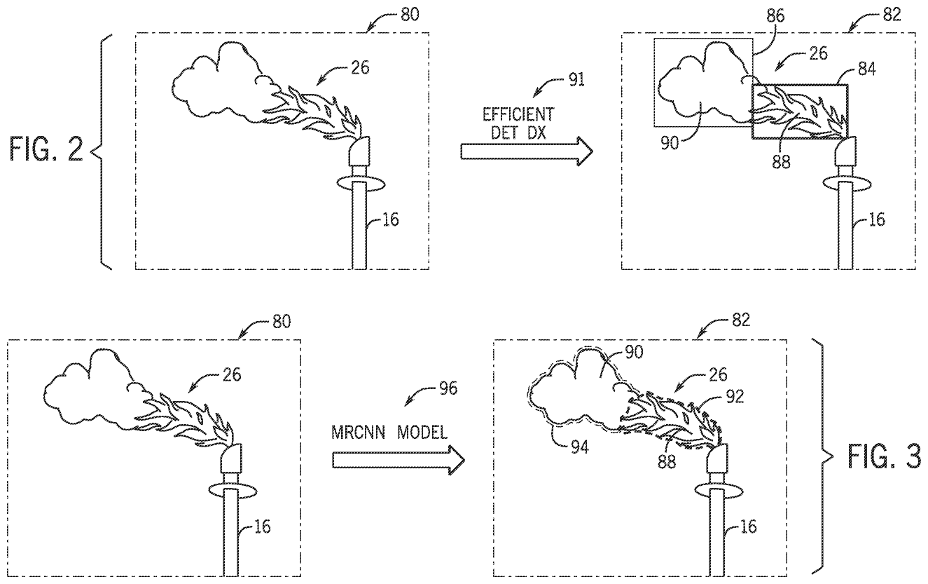

FIGS. 2 and 3 are provided as examples of rectangular bounding boxes and polygon masks, respectively, identified by the flare monitoring assembly 14 of FIG. 1 based on images taken by the camera assembly 40 of the flare monitoring assembly 14. For example, FIG. 2 is an illustration of an embodiment of an image 80 of the flare 26 captured by the camera assembly 40 of the flare monitoring assembly 14 of FIG. 1 and a reproduction 82 of the image 80 with superimposed rectangular bounding boxes 84, 86 determined by the flare monitoring assembly 14 of FIG. 1. The first rectangular bounding box 84 may correspond to a flame 88 and the second rectangular bounding box 86 may correspond to smoke 90. Further, the rectangular bounding boxes 84, 86 may be determined by the control device 30 of FIG. 1 via an object identification module 91 employing, for example, an EfficientDet Dx model. It should be noted that the following, relating to example features of an EfficientDet model, is incorporated by reference: MINGXING TAN et al., “EfficientDet: Scalable and Efficient Object Detection,” CVPR 2020.

Further, FIG. 3 is an illustration of an embodiment of the image 80 of the flare 26 captured by the camera assembly 40 of the flare monitoring assembly 14 of FIG. 1 and the reproduction 82 of the image 80 with superimposed polygon masks 92, 94 determined by the flare monitoring assembly 14 of FIG. 1. The first polygon mask 92 may correspond to the flame 88 and the second polygon mask 94 may correspond to the smoke 90. Further, the polygon masks 92, 94 may be determined based on an instance segmentation module 96 employing, for example, a Mask R-CNN (MRCNN). It should be noted that the following, relating to example features of an MRCNN model, is incorporated by reference: KAIMING H E et al., “Masks R-CNN,” In CVPR, 2018.

As described in detail below, one or more of the rectangular bounding boxes 88, 90 or one or more of the polygon masks 92, 94 may be employed, along with at least one other input (e.g., internal diameter of the flare stack 16), to determine certain KPIs of the gas flare assembly 12 of FIG. 1, such as the flow rate of the hydrocarbon gas 23 through the flare stack 16.

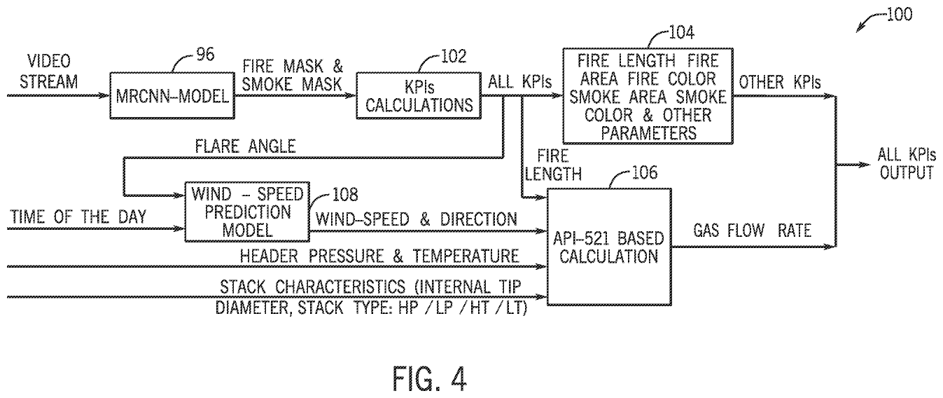

FIG. 4 is a process flow diagram corresponding to an embodiment of a process 100 performed by the flare monitoring assembly 14 of FIG. 1 to determine key performance indicators (KPIs), such as a gas flow rate, corresponding to the gas flare assembly 12 of FIG. 1. In the illustrated embodiment, the process 100 includes processing a video stream (e.g., corresponding to the first input 50 indicative of images taken by the camera assembly 40 of FIG. 1) via the instance segmentation module 96 (e.g., MRCNN model) to generate masks, such as a first mask corresponding to a flame or fire and a second mask corresponding to smoke. The process 100 also includes calculating (block 102) certain KPIs based on the masks, and outputting (block 104) said calculations (e.g., fire length, center line of fire, fire area, fire color, smoke area, smoke color, and other parameters). It should be noted that, in certain embodiments, a Deep-Learning model may be employed to estimate at least the fire length and/or center line of fire (e.g., based on the images or video feed taken by the camera assembly) without the use of the polygon mask(s) and/or rectangular bounding box(es), and the various KPIs may be estimated based on the fire length and/or the center line of fire.

The process 100 also includes calculating (block 106) gas flow rate based on the fire length (e.g., produced via block 102) and additional inputs. The additional inputs may include, for example, estimated wind speed and direction calculated at block 108 via a wind-speed prediction model and/or based on wind speed sensor data. Further, the inputs to the calculation (block 106) may include header pressure and temperature and stack characteristics (e.g., internal tip diameter and/or stack type, such as high pressure type, low pressure type, high temperature type, or low temperature type). Based on the calculation (block 106), which may employ an API-521 model or reference table, the control device 30 of FIG. 1 may estimate gas flow rate via the process 100 of FIG. 4. It should be noted that the following, relating to example features of an API-521 model, is incorporated by reference: “Pressure-relieving and Depressuring Systems,” API STANDARD 521, SEVENTH EDITION, JUNE 2020.

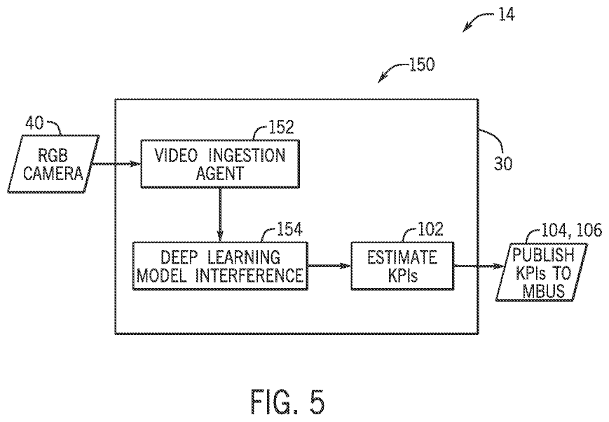

FIG. 5 is a schematic view of an embodiment of a portion 150 of the flare monitoring assembly 14 of FIG. 1. The portion 150 of the flare monitoring assembly 14 in FIG. 5, as previously described, includes the camera assembly 40, which may include at least one RBC camera, configured to capture images (e.g., via a video feed) of a flare corresponding to a flare stack. A video ingestion agent 152 may be configured to receive data corresponding to the images from the camera assembly 40. The video ingestion agent 152 may be configured, for example, to connect various componentry of the flare monitoring assembly 14, such as the camera assembly 40 and one or more of the sensors described above with respect to FIG. 1. The deep learning model interface 154 may be configured to receive data from the video ingestion agent 152 and implement or otherwise execute the aforementioned MRCNN model or EfficientDet Dx model to generate polygon masks corresponding to the flare (e.g., including at least one flame or fire mask and at least one smoke mask) or rectangular bounding boxes corresponding to the flare (e.g., including at least one flame or fire box and at least one smoke box). Based on the above-described model(s), KPIs corresponding to the gas flare assembly 12 of FIG. 1 may be estimated at block 102 and then output to a message bus at the block 104.

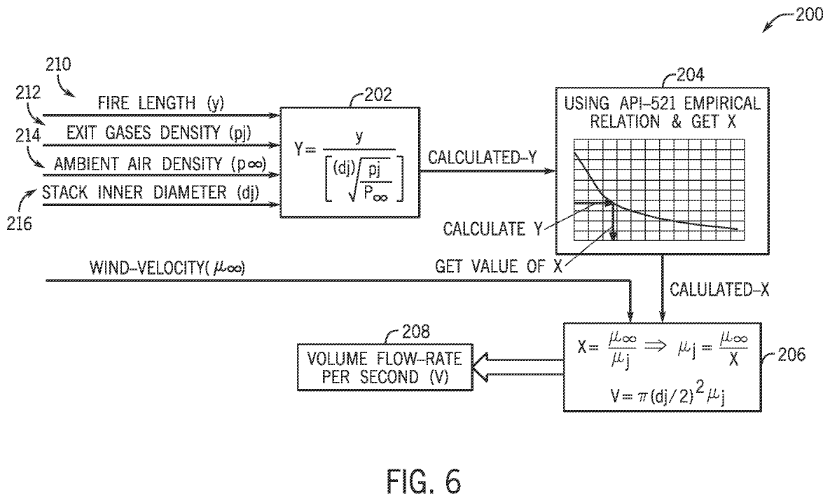

FIG. 6 is a process flow diagram 200 illustrating an embodiment of one or more algorithms employed, for example, in the process 100 of FIG. 4. The process flow diagram 200 illustrates a first algorithm portion 202, an API-521 model 204 (e.g., reference table or graph), and a second algorithm portion 206 employed in conjunction to output a volume flow rate per second 208 (e.g., of the hydrocarbon gas through flare stack or header). The first algorithm portion 202 may receive, for example, first data 210 indicative of fire (or flame) length (y), second data 212 indicative of exit gases density (ρⱼ), third data 214 indicative of ambient air density (ρ_{∞}), and fourth data 216 indicative of stack tip inner diameter (dⱼ). This data may be employed in the first algorithm portion 202 as follows:

$$Y = \frac{y}{[ ( dj ) \sqrt{\frac{ρ j}{ρ ∞}}} \qquad Equation 1$$

The value output by the first algorithm portion 202, or Y, may be employed by the API-521 model 204 (e.g., reference table or graph) to locate X, as shown in FIG. 6. Further, the second algorithm portion 206 may receive inputs corresponding to X and wind velocity (μ_{∞}), where:

$$X = \frac{{μ}_{∞}}{{μ}_{j}} \qquad Equation 2$$

After employing Equation 2 to solve for ρⱼ, the second algorithm portion 206 may solve for volume flow rate per second (V) as shown in FIG. 6 and set forth below:

V=π(dⱼ/2)²μⱼ Equation 3:

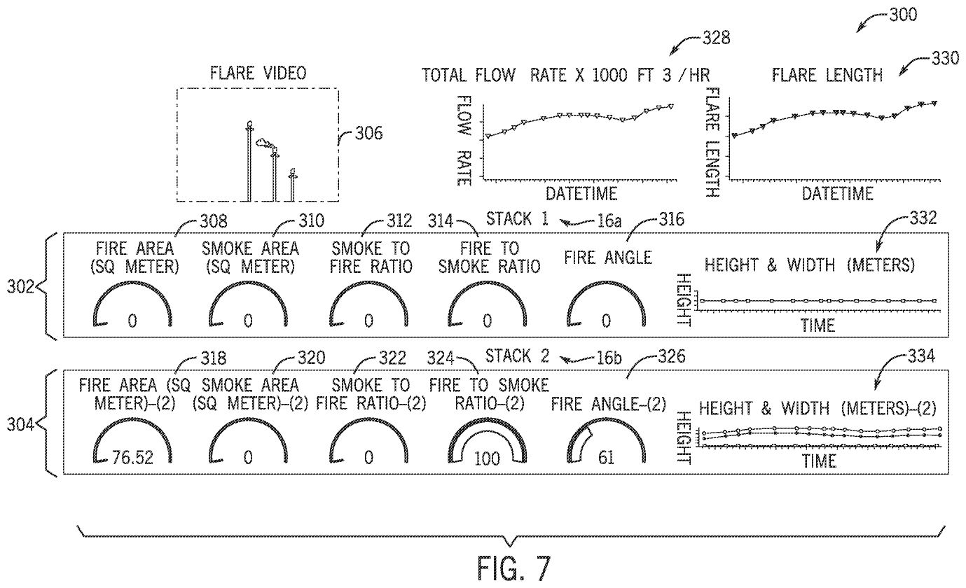

FIG. 7 is an illustration of an embodiment of key performance indicators (KPIs) presentable on a graphical user interface (GUI) 300, determined by the flare monitoring assembly 14 of FIG. 1, and corresponding to first and second flare stacks 16a, 16b (e.g., of the gas flare assembly 12 of FIG. 1). For example, first KPIs 302 corresponding to the first flare stack 16a and second KPIs 304 corresponding to the first flare stack 16a are shown. The first KPIs 302 include fire (or flame) area 308, smoke area 310, smoke to fire (or flame) ratio 312, fire (or flame) to smoke ratio 314, and fire (or flame) area 316. Likewise, the second KPIs 304 include fire (or flame) area 318, smoke area 320, smoke to fire (or flame) ratio 322, fire (or flame) to smoke ratio 324, and fire (or flame) area 326. Also shown on the GUI 300 is a first graph 328 illustrating flow rate over time, a second graph 330 illustrating fire (or flame) length over time, a third graph 332 corresponding to the first flare stack 16a and illustrating fire (or flame) and smoke height and width over time, and a fourth graph 334 corresponding to the second flare stack 16b and illustrating fire (or flame) and smoke height and width over time. Finally, an embedded video 306 of the first flare stack 16a and/or the second flare stack 16b may be included. The embedded video 306 may be a real-time or near real-time live feed, or the embedded video 306 may be recorded for presentment on the GUI 300 at a later moment in time.

The present disclosure may provide one or more technical effects useful in hydrocarbon gas flaring. For example, presently disclosed embodiments may enable improved flare monitoring at a lower cost than traditional configurations, and may enable a reduced environmental impact of hydrocarbon gas flaring.

While only certain features and embodiments of the disclosure have been illustrated and described, many modifications and changes may occur to those skilled in the art, such as variations in sizes, dimensions, structures, shapes and proportions of the various elements, values of parameters, including temperatures and pressures, mounting arrangements, use of materials, colors, orientations, and so forth without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described, such as those unrelated to the presently contemplated best mode of carrying out the disclosure, or those unrelated to enabling the claimed disclosure. It should be noted that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A flare monitoring system, comprising:
a camera configured to capture one or more images of a burning portion of a hydrocarbon gas emitted from a flare stack;
memory circuitry storing instructions thereon; and
processing circuitry configured to execute the instructions to estimate a flow rate of the hydrocarbon gas based on:
first data corresponding to the one or more images; and
second data corresponding to an internal diameter of the flare stack.

2. The flare monitoring system of claim 1, wherein the processing circuitry is configured to execute the instructions to:
determine, based on the first data, one or more rectangular bounding boxes corresponding to the burning portion of the hydrocarbon gas; and
estimate the flow rate based on third data corresponding to one or more sizes of the one or more rectangular bounding boxes.

3. The flare monitoring system of claim 1, wherein the processing circuitry is configured to execute the instructions to:
determine, based on the first data and an object identification model, a first rectangular bounding box corresponding to fire of the burning portion of the hydrocarbon gas and a second rectangular bounding box corresponding to smoke of the burning portion of the hydrocarbon gas; and
estimate, based on the first rectangular bounding box and the second rectangular bounding box, a plurality of key performance indicators (KPIs) of a gas flare system employing the flare stack.

4. The flare monitoring system of claim 1, wherein the processing circuitry is configured to execute the instructions to:
determine, based on the first data and a masking algorithm, one or more polygon masks corresponding to the burning portion of the hydrocarbon gas; and
estimate the flow rate based on third data corresponding to one or more sizes of the one or more polygon masks.

5. The flare monitoring system of claim 1, wherein the processing circuitry is configured to execute the instructions to:
determine, based on the first data and an instance segmentation model, a first polygon mask corresponding to fire of the burning portion of the hydrocarbon gas and a second polygon mask corresponding to smoke of the burning portion of the hydrocarbon gas; and
estimate, based on the first polygon mask and the second polygon mask, a plurality of key performance indicators (KPIs) of a gas flare system employing the flare stack.

6. The flare monitoring system of claim 1, wherein the processing circuitry is configured to execute the instructions to estimate the flow rate based on third data corresponding to wind speed adjacent to the burning portion of the hydrocarbon gas.

7. The flare monitoring system of claim 6, comprising one or more sensors configured to detect the wind speed.

8. The flare monitoring system of claim 6, wherein the processing circuitry is configured to execute the instructions to estimate the wind speed based on:
an autoregressive model (ARIMA) that employs historic wind speed data; or
a flare angle corresponding to the burning portion of the hydrocarbon gas; or
a combination of the ARIMA and the flare angle.

9. The flare monitoring system of claim 1, wherein the processing circuitry is configured to execute the instructions to estimate the flow rate based on third data corresponding to:
a pressure of the hydrocarbon gas within the flare stack; or
a temperature of the hydrocarbon gas within the flare stack; or
a material composition of the hydrocarbon gas within the flare stack; or
a combination of two or more of the pressure, the temperature, or the material composition.

10. The flare monitoring system of claim 1, wherein the processing circuitry is configured to execute the instructions to:
determine, based on the first data and a Deep-Learning model, a center line and a length corresponding to fire from the burning portion of the hydrocarbon gas; and
estimate, based on the length of the fire, a plurality of key performance indicators (KPI) of a gas flare system employing the flare stack.

11. One or more tangible, non-transitory, computer-readable media storing instructions thereon that, when executed by one or more processors, are configured to cause the one or more processors to:
receive first data corresponding to one or more images taken by a camera of a burning portion of a hydrocarbon gas emitted from a flare stack;
receive second data corresponding to an internal diameter of the flare stack; and
estimate, based on the first data and the second data, a flow rate of the hydrocarbon gas through the flare stack or a flare header upstream of the flare stack.

12. The one or more tangible, non-transitory, computer-readable media of claim 11, wherein the instructions, when executed by the one or more processors, are configured to cause the one or more processors to estimate the flow rate based on third data corresponding to a pressure or a temperature of the hydrocarbon gas within the flare stack or the flare header.

13. The one or more tangible, non-transitory, computer-readable media of claim 11, wherein the instructions, when executed by the one or more processors, are configured to cause the one or more processors to estimate the flow rate based on third data corresponding to a pressure of the hydrocarbon gas within the flare stack or the flare header and fourth data corresponding to a temperature of the hydrocarbon gas within the flare stack or the flare header.

14. The one or more tangible, non-transitory, computer-readable media of claim 11, wherein the instructions, when executed by the one or more processors, are configured to cause the one or more processors to estimate the flow rate based on third data corresponding to a wind speed adjacent to a tip of the flare stack.

15. The one or more tangible, non-transitory, computer-readable media of claim 11, wherein the instructions, when executed by the one or more processors, are configured to cause the one or more processors to:
determine, based on the first data, one or more rectangular bounding boxes corresponding to the burning portion of the hydrocarbon gas; and
estimate the flow rate based on one or more sizes of the one or more rectangular bounding boxes.

16. The one or more tangible, non-transitory, computer-readable media of claim 11, wherein the instructions, when executed by the one or more processors, are configured to cause the one or more processors to:
determine, based on the first data and a masking algorithm, one or more polygon masks corresponding to the burning portion of the hydrocarbon gas; and
estimate the flow rate of the hydrocarbon gas based on third data corresponding to one or more sizes of the one or more polygon masks.

17. A method, comprising:
capturing, via a camera assembly, one or more images of a burning portion of a hydrocarbon gas emitted from a flare stack;
receiving, via processing circuitry, first data corresponding to the one or more images; and
estimating, via the processing circuitry, based on the first data, and based on second data corresponding to an internal diameter of the flare stack, a flow rate of the hydrocarbon gas through the flare stack or a flare header upstream of the flare stack.

18. The method of claim 17, comprising:
determining, via the processing circuitry and based on the first data, one or more rectangular rounding boxes corresponding to the burning portion of the hydrocarbon gas;
determining, via the processing circuitry, one or more sizes of the one or more rectangular rounding boxes; and
estimating, via the processing circuitry, the flow rate based on third data corresponding to the one or more sizes.

19. The method of claim 17, comprising:
determining, via the processing circuitry, based on the first data, and based on a masking algorithm, one or more polygon masks corresponding to the burning portion of the hydrocarbon gas;
determining, via the processing circuitry, one or more sizes corresponding to the one or more polygon masks; and
estimating, via the processing circuitry and based on third data corresponding to the one or more sizes, the flow rate.

20. The method of claim 17, comprising estimating, via the processing circuitry, the flow rate based on:
third data corresponding to a pressure of the hydrocarbon gas within the flare stack or the flare header;
fourth data corresponding to a temperature of the hydrocarbon gas within the flare stack or the flare header; and
fifth data corresponding to a wind speed adjacent to a tip of the flare stack.
